(19) United States
(12) Patent Application Publication
(10) Pub. No.: US 2019/0034496 A1
(43) Pub. Date: Jan. 31, 2019

(54) Abstract Query Processing Using Metadata on Multiple Complex Data Sources

(71) Applicant: Citrix Systems, Inc., Fort Lauderdale, FL (US)

(72) Inventors: Rodney Gallart Acosta, Plantation, FL (US); Katia Lopez Rodriguez, Plantation, FL (US); Nizar Tyrewalla, Boca Raton, FL (US); Rohit Garg, Pompano Beach, FL (US)

(21) Appl. No.: 15/661,325

(22) Filed: Jul. 27, 2017

(51) Int. Cl. G06F 17/30

(52) U.S. Cl. CPC G06F 17/30545; G06F 17/30867; G06F 17/30451; G06F 17/30554

(57) ABSTRACT

Systems and methods for performing a query using abstracted metadata are described. As described, a metadata object that requests data from a plurality of data sources can be received from, for example, a user device. One or more queries for the one or more of the plurality of data sources based upon the metadata object can be generated. The queries can then be transmitted to the one or more data sources. Results of the queries, according to the method, can be stored in a block memory. In various embodiments, the metadata object may be user-generated and define one or more of a data source, filter conditions, sorting conditions, aggregations criteria, and an operation. Additionally, various embodiments describe updating the queries at pre-determined intervals which can be defined by the metadata object.

### FIELD

Aspects described herein generally relate to computers, computer networks, and data processing. More specifically, aspects described herein relate to systems and methods that facilitate abstracted querying using metadata across multiple complex data sources.

### BACKGROUND

Data storage is an essential part of modern computing and, particularly, of any data-centric application. Users require functionality from data storage that includes reading and writing of large amounts of data, executing queries, and joining large data sets in order to perform analysis of the data. In many systems relevant data is stored across multiple data sources and it can be necessary for a user to quickly and efficiently perform various functions on data from several data sources at once. However, as the amount of stored data grows in size, the structure of the data changes, or if data stored in one format needs to be joined with data in another format, the difficulty of performing the required functions on the data increases.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and methods that allow abstracted queries using metadata. As described herein, in various embodiments, a method is provided for performing a query. According the methods, a metadata object that requests data from a plurality of data sources can be received from, for example, a user device. The method may then generate one or more queries for the one or more of the plurality of data sources based upon the metadata object. The queries can then be transmitted to the one or more data sources. Results of the queries, according to the method, can be stored in a block memory. In various embodiments, the metadata object may be user-generated and define one or more of a data source, filter conditions, sorting conditions, aggregations criteria, and an operation. Additionally, various embodiments describe updating the queries at pre-determined intervals which can be defined by the metadata object.

In some embodiments, the method may further comprise performing one or more operations on one or more results from the query based on an operation specified in the metadata object. The results of the one or more operations can be stored in block memory in some embodiments and/or transmitted to a remote user device.

Various embodiments also include a system that is capable of performing an abstracted query by processing metadata. The system may include a block memory and one or more processors. The processors may be configured to receive a metadata object. The metadata object may contain information that requests data from plurality of data sources. The processors may further be configured to generate one or more queries corresponding to the one or more of the plurality sources defined by the meta data object and to transmit those generated queries to the one or more data sources. The one or more processors can further be configured to receive the results of the one or more queries from the one or more data sources and to store the one or more results from the one or more queries in the block memory.

According to some embodiments, the one or more processors can be further configured to determine that at least some of the requested data is present in block memory and, based on that determination, decline to generate a query for the requested data that is already present in the block memory. Additionally, in embodiments, the one or more processors may be further configured to update the one or more queries at pre-determined intervals that, in some embodiments, are defined by the received metadata object. The processors may also be configured to store the metadata object for later execution.

In some embodiments, the one or more processors may be further configured to perform one or more operations on one or more results from the query based on an operation specified in the metadata object. The results of the one or more operations can be stored in block memory in some embodiments and/or transmitted to a remote user device.

Some embodiments include non-transitory computer media that stores computer instructions which, when executed by one or more processors, causes the performance of operations that include receiving a metadata object requesting data from a plurality of data sources. The non-transitory computer medium may also contain instructions that cause the processors to generate one or more queries corresponding to the one or more of the plurality sources defined by the meta data object and to transmit those generated queries to the one or more data sources. Additionally, the non-transitory computer medium may contain instructions that cause the processors to receive the results of the one or more queries from the one or more data sources and to store the one or more results from the one or more queries in the block memory.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts a system architecture in accordance with one or more illustrative aspects described herein.

FIG. 4 depicts a system architecture in accordance with one or more illustrative aspects described herein.

FIG. 5 is a sequence diagram depicting a sequence of communication in a system in accordance with one or more illustrative aspects described herein.

FIG. 6 is a flowchart depicting a method in accordance with one or more illustrative aspects described herein.

FIG. 7 is a flowchart depicting a method in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards controlling remote access to resources at an enterprise computing system using managed mobile applications at mobile computing devices. An access manager may perform a validation process that determines whether a mobile application requesting access to enterprise resources has accurately identified itself and has not been subsequently altered after installation at the mobile computing device. In this way, the access manager may ensure the mobile application requesting access to the enterprise resource can be trusted and is not attempting to circumvent the security mechanisms used to protect those enterprise resources. As a result, individuals associated with the enterprise may advantageously utilize enterprise resources at their personal mobile devices.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

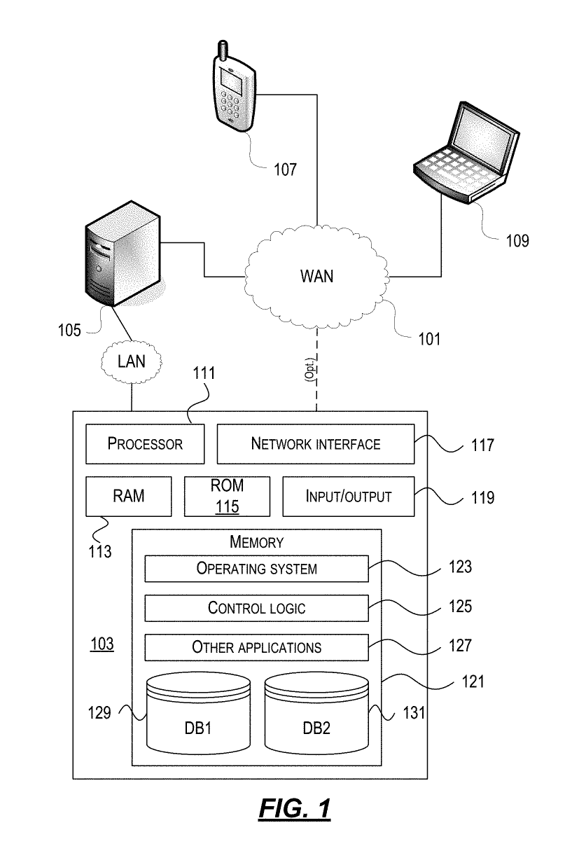

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

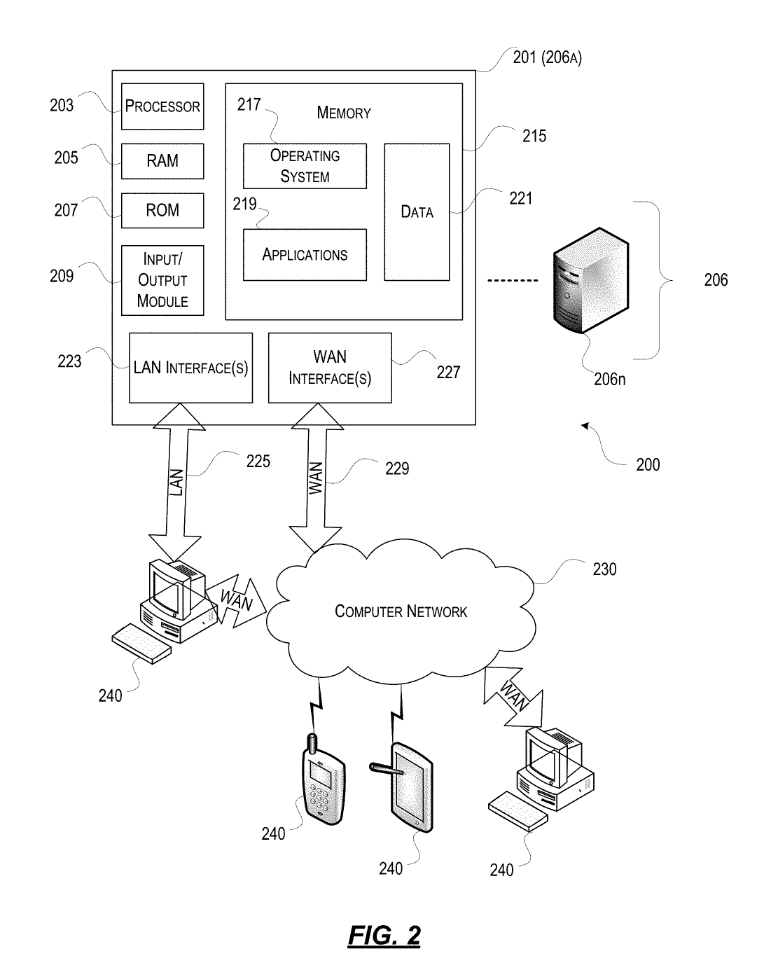

With further reference to FIG. 2, one or more aspects described herein may be implemented in a remote-access environment. FIG. 2 depicts an example system architecture including a generic computing device 201 in an illustrative computing environment 200 that may be used according to one or more illustrative aspects described herein. Generic computing device 201 may be used as a server 206a in a single-server or multi-server desktop virtualization system (e.g., a remote access or cloud system) configured to provide virtual machines for client access devices. The generic computing device 201 may have a processor 203 for controlling overall operation of the server and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of generic computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring generic computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). The terminals 240 may be personal computers, mobile devices, laptop computers, tablets, or servers that include many or all of the elements described above with respect to the generic computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while and logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 and well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

Abstract Query Processing

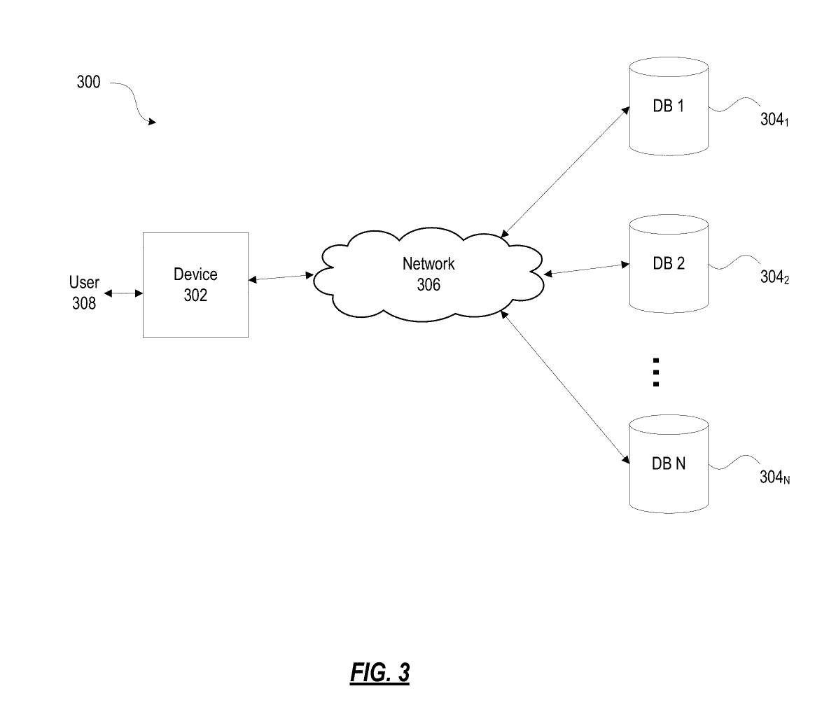

FIG. 3 is a block diagram depicting a system 300 according to various aspects of the disclosure. The system 300, can generally contain a device 302 (similar, in embodiments, to computing device 201) connected to an arbitrary number of data stores 304₁, 304₂, . . . , and 304_{N} (generically referred to has data stores 304) via a network connection 306. A user 308 may access device 302 and use it to query the data store 304 via network connection 306.

According to various embodiments data stores 304 may comprise any appropriate data storage resource such as servers, databases (e.g., structured query language (SQL), relational, unstructured, or semi-structured databases, to name a few possible examples), or network drives, for example. Additionally, one or more of data stores 304 may have a unique protocol and/or syntax for generating a query on the data store 304. For example, data store 304₁ could be an SQL-based database, whereas data store 304₂ could use some other format such as Extensible Markup Language (XML) format.

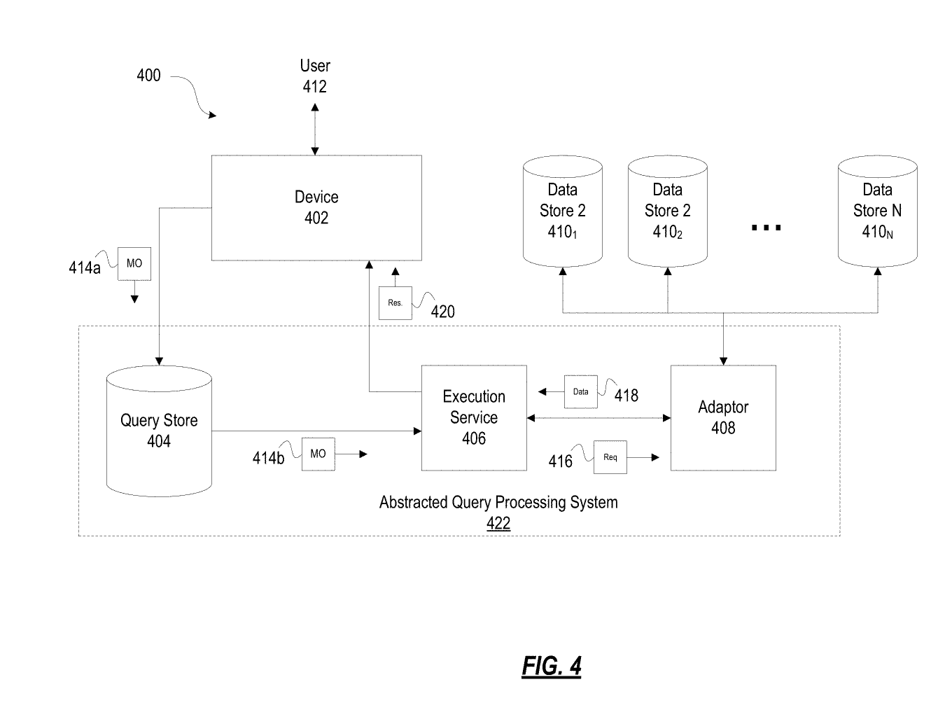

From time to time information that a user 308 of device 302 would like to access may be stored on a number of different data stores 304. For instance, consider a situation where sales data for a company's product is stored on a first data store (e.g., data store 304₁) and usage data for the same produce is stored on a second data store (e.g., data store 304₂) In this example, if a user 308 of device 302 wanted to correlate the sales data with the usage data for the product, the user 308 would have query each data source 304₁ and 304₂ and receive their separate responses before performing the correlation. This approach has several problems. First, it can introduce delay in that separate queries for each of the relevant data sources 304 must be generated by the user 308 and transmitted to various data sources 304. Second, this approach requires the user to be familiar with the several different formats and their proper syntax in order to formulate the multiple queries. Third, it makes changing the formats of any of the data stores 304 problematic because each user must be subsequently informed so that they will be able to properly format any required search query. A different method would be to employ a system that allows a user to transmit abstracted query data to a central system that can handle generating the queries for the user. Such a system is described with respect to FIG. 4.

FIG. 4 depicts a system 400 that utilizes abstracted queries, according to various embodiments of the disclosure. The system 400 includes a device 402 that communicates with a query store 404 and an execution service 406. An adaptor device 408 communicates with execution service 406 and with a number of data stores 410₁, 410₂, . . . , 410_{N} (generically referred to as data stores 410). A user 412 can interact with device 402 via a user interface (not shown) that is part of device 402. Query store 404, execution service 406, and adaptor 408 may form part of abstracted query processing system 422. In various embodiments, each of the components of abstracted query processing system 422 may be distributed and remote from each other, though in some embodiments one or more of query store 404, execution service 406, and adaptor 408 may be centrally located as well.

In general, device 402 may comprise any suitable computer device such as computing device 201. Query store 404 may comprise one or more data stores (e.g., servers, databases, network drives, or some combination thereof, to name a few non-limiting examples) capable of storing query data transmitted by device 402. Execution service 406 and adaptor 408 may each comprise one or more servers (e.g., servers 206, described above). Data stores 410 may be similar data stores 304 in that they may comprise any appropriate data storage resource such as servers, databases (e.g., structured query language (SQL), relational, unstructured, or semi-structured databases, to name a few possible examples), or network drives, for example. Additionally, one or more of data stores 410 may have a unique protocol and/or syntax for generating a query.

As mentioned above, system 400 allows the use of abstracted queries by a user 412 to submit queries to multiple data stores 410. In this way, system 400 frees the end-user 412 from the need to know the underlying data structures for any of the data sources 410 in order to perform a query across one or more of the data sources 410. In general, the system 400 works by creating a query metadata object (e.g., metadata objects 414a and 414b) based on user 412 input. A query metadata object 414 can be formed using a simple user interface (e.g., a drop down menu, a wizard, a form, or the like) to populate the key values of the query metadata object. Various fields in the user interface can be linked or dependent on each other to help user to narrow down the choices.

According to various embodiments, a query metadata object 414 may contain data specifying, for example, a query frequency, a specific time to run the query, a data source name, filter conditions, sorting conditions, and aggregate conditions to form a variety of widely used queries to analyze the data. In some examples, metadata objects 414 may comprise any suitable data object such as a JavaScript Object Notation (JSON) object. Such data objects may be populated with appropriate values by device 402 using the user 412 inputs discussed above. Once generated, the metadata object 414 can be transmitted to the query store 404 for later use. In some embodiments, the query store may compile and/or perform a rules check on the metadata object 414 upon receipt. If an error occurs, an appropriate error message may be transmitted back the device 402. However, in some embodiments, it is also possible for the device 402 to perform the compilation/rules check on the metadata object 414 prior to transmission. Because metadata objects 414 are stored in query store 404, they can be re-used so that the user 412 and device 402 do not have to generate the same metadata object 414 multiple times.

When it is time to run a particular query, the query store 404 can transmit the metadata objects (e.g., metadata object 414b) to the execution service 406 to generate appropriate request for the various data stores 410. The properly generated requests 416 can then be transmitted to the adaptor 408 for transmission to the appropriate data stores 410. The data 418 resulting from the requests can then transmitted by the adaptor 408, upon its receipt from the data stores 410, to the executing service 406 for processing (e.g., performance of various database or analytical operations). The results 420 of the processing can then be transmitted to device 402 from the execution service 406 for use by user 412.

As a practical example of the operation of system 400, consider a scenario in which a user 412 wishes to perform a JOIN operation on two different data sources—data source 410₁ and 410₂. Consider, further, that data sources 410₁ and 410₂ are stored independently and in different type of stores, but that they have some common attribute on which user wants to perform the JOIN operation. In this case, the device 402 would begin by generating a metadata object 414 using input from user 412. The metadata object 414 would contain information specifying the data sources 410₁ and 410₂, the attribute in question, and the fact that a JOIN operation should be performed. The metadata object 414 can then be stored in the query store 404 after compilation and/or passing a rules check.

When query is to be executed, the query store 404 can transmit the metadata object 414 to execution service 406. The execution service will then generate two request: a first request for a query on the attribute on data source 410₁ and a second request for a query on the attribute for data source 410₂. The requests 416 will then be sent to the adaptor 408 for transmission to data sources 410₁ and 410₂. When data sources 410₁ and 410₂ return the data to the adaptor 408 the data 418 is transmitted to the execution service 406. In some embodiments, the execution service 406 may save the data from data sources 410₁ and 410₂ in blocks of data in a memory The execution service can then perform the specified JOIN operation on the two sets of data from data sources 410₁ and 410₂. The results 420 of the JOIN operation can then be transmitted to device for the user to view.

According to some embodiments, prior to generating the requests for adaptor, the execution service 406 may determine whether some or all of the data requested by the metadata object 414 has been previously requested. If it has been and it is still saved in the memory of the execution service 406, then the execution service 406 may decline to generate a request to retrieve that data. For instance, returning to our example, if the data for the attribute from the first data source 410₁ had been previously requested, then the execution service 406 might determine that it is only necessary to generate a request for data from the second data source 410₂. Additionally, in some embodiments, the execution service 406 may determine that data has been previously requested and is present in the memory of the execution service 406 but may, nevertheless, determine to generate a request for the data because the data in the memory of the execution service 406 is “stale” and/or needs to be updated.

According to various embodiments, the execution service 406 can maintain a record of the type of each data source 410. However, that information may also be provided as part of the metadata object 414. At any rate, according to the various embodiments, the execution service 406 knows the type of the various data sources 410 from which data will be requested according to the query metadata object 414. Accordingly, in generating the specific requests, the execution service 406 can tailor each request to the specific format and syntax of that data source 410. Furthermore, the execution service 406 can be configured to handle the various formats in which the data sources 410 will return their results. For instance, continuing with the JOIN example above, if data source 410₁ is an SQL server and data store 410₂ is a document store, the execution service 406 can perform the join by creating temporary table in the SQL server. In the case of the document store server, the query can be converted to an aggregate pipeline to get the desired result back. According to some embodiments, this query execution mechanism can also be used to perform incremental results on large data sets. For instance, JOIN operations and aggregate operations can take a relatively long time to perform. By using the incremental approach, system 400 can limit the number of rows that are processed and return the result to the user 412 as needed, only performing operations on subsequent rows as user 412 demands more data (e.g., by paging or scrolling or the like).

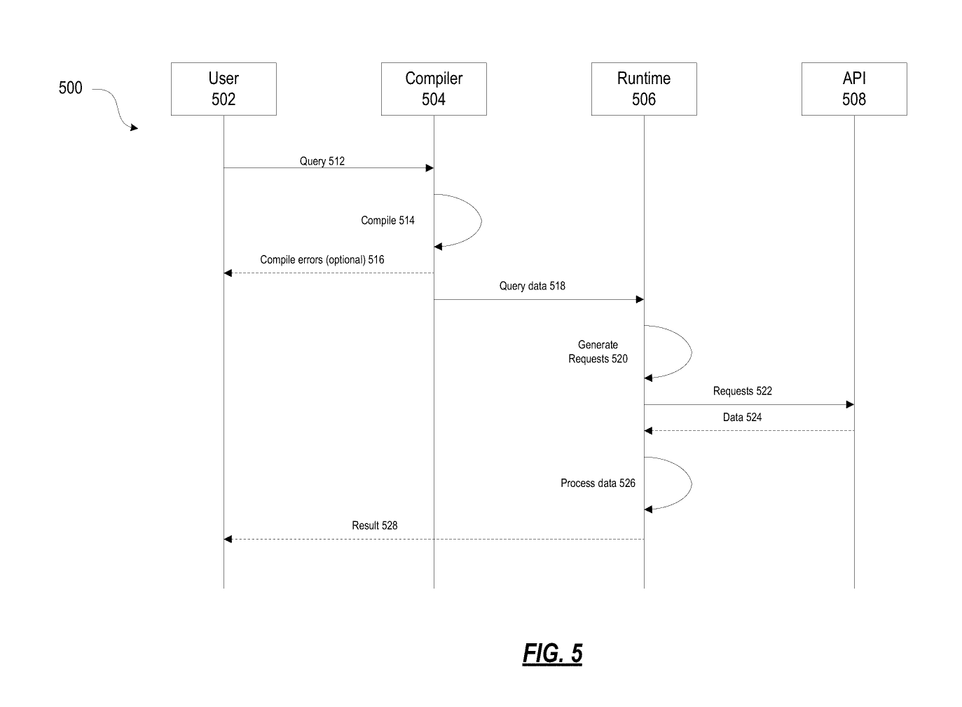

FIG. 5 is a sequence diagram 500 displaying various steps of performing abstracted queries based on metadata objects in accordance with the various embodiments of this disclosure. To aid understanding, FIG. 5 will be described with respect to system 400 shown in FIG. 4. However, it should be understood that the embodiment of FIG. 5 is not limited to the specific embodiment depicted in FIG. 4.

The sequence diagram 500 shown in FIG. 5 has a user operator 502, a compiler operator 504, a runtime operator 506, and an API operator 508. According to various embodiments, the user 502 may be a combination of the device 402 and the user 412. According to various embodiments, the compiler may operate as part of the device 402, query store 404, or execution service 406. The runtime operator 506 can be implemented by the execution service 406 in various embodiments, and the API operator 508 may be implemented by the adaptor 408.

At the beginning of the sequence 500, the user 502 generates and sends an abstracted query 512 to compiler 504. As noted above, the query may take the form of a metadata object 414. Additionally, the query 512 may contain data specifying, for example, a query frequency, a specific time to run the query, a data source name, filter conditions, sorting conditions, and aggregate conditions to form a variety of widely used queries to analyze the data. In some examples, metadata objects 414 may comprise any suitable data object such as a JavaScript Object Notation (JSON) object.

When the compiler 504 receives the query 512 from the user 502 it may then attempt to compile 514 the query and/or perform a rules check on the query 512. According to various embodiments the compiler may attempt to verify that the query 512 contains all the necessary information to generate appropriate requests for each of the data sources that comprise the query. If the compiler finds that the query 512 fails to compile and/or fails to pass the rule check, then the compiler 504 may optionally transmit a message indicating one or more errors 516 to user 502.

Upon successful compilation and/or passing a rules check, the compiler 504 may transmit query data 518 to the runtime object 506. According to some embodiments, the compiler may additionally convert the query 512 into an intermediate data structure such as an abstract syntax tree (AST). After receiving the query data 518 (possibly in the form of the intermediate data structure), the runtime 506 may generate one or more requests based on the query 518. According to various embodiments, the runtime 506 may generate appropriate requests for each of a plurality of data sources (e.g., data sources 410) specified by query 518. However, as discussed above, the runtime 506 may determine whether some or all of the data requested by query data 518 has been previously requested. If it has been and it is still saved in the memory associated with the runtime environment 506, then requests for that data may not be generated. Additionally, in some embodiments, runtime 506 may determine that data has been previously requested and is present in the memory associated with runtime 506 but may, nevertheless, determine to generate a request for the data because the data in the memory needs to be updated.

After generating one or more requests 520, runtime 506 transmits a message 522 containing the one or more requests 520 to API 508. API 508 may then subsequently transmit the one or more generated requests 520 to the appropriate data sources 410 and receive data from the data sources 410 responding to the requests. The API 508 can then transmit the data to runtime 506 where it can be stored in, for instance, block memory for subsequent processing. After receiving the data responsive to the generated requests 520, runtime 506 may process the data at 526. For instance, the runtime 506 may process the received data by performing various database operations (e.g., join, aggregate, and the like) on received data. After processing the data, runtime 506 may transmit the result 528 to the user 502.

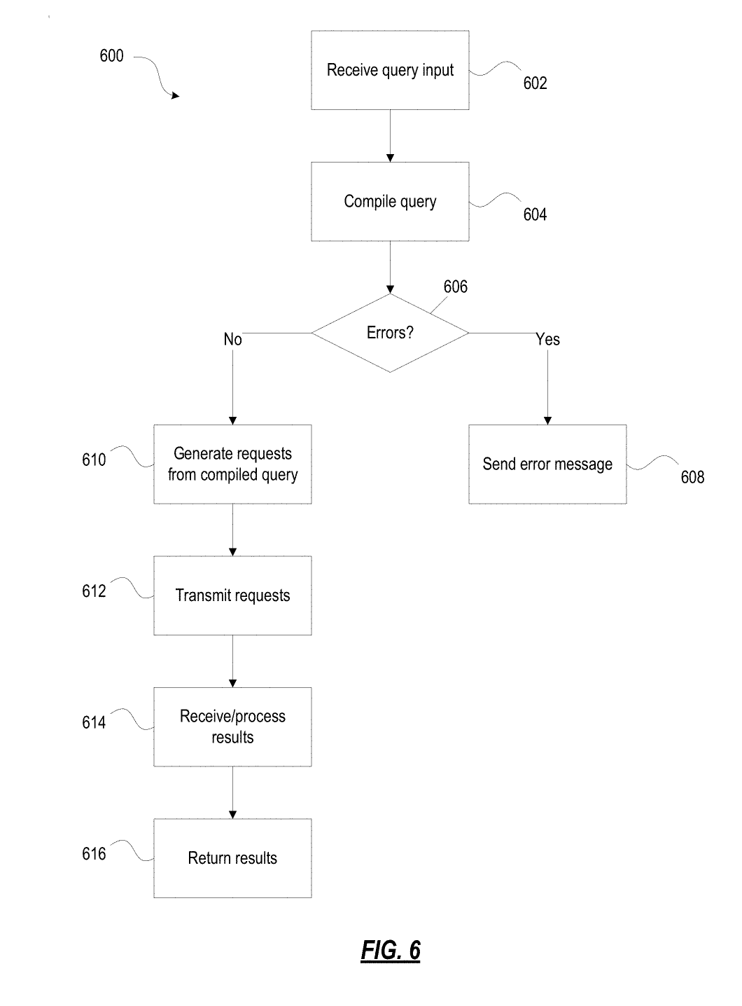

FIG. 6 is a flowchart depicting a method 600 according to various embodiments. To aid understanding, FIG. 6 will be described with reference to FIGS. 4 and 5, but it should be understood that the method 600 is not limited to the specific embodiments described in connection with those figures.

As shown in FIG. 6, method 600 begins when a query input is received at 602. According to various embodiments the query input may take the form of a query metadata object 414 (as shown in FIG. 6) and may contain data specifying, for example, a query frequency, a specific time to run the query, a data source name, filter conditions, sorting conditions, and aggregate conditions to form a variety of widely used queries to analyze the data. The query input may also comprise any suitable data object such as a JavaScript Object Notation (JSON) object.

At 604, the method 600 may compile and/or perform a rules check on the received query input to ensure the query input is viable. For instance, according to various embodiments the compilation verifies that the query input contains all the necessary information to generate appropriate requests for each of the data sources that comprise the query. According to some embodiments, the compile step 604 may also include converting the query input into an intermediate data structure such as an abstract syntax tree. At 606, the method determines if there are any compilation errors. If so, then an error message can be sent at 608 to, for instance, user device 402.

If there are no compilation errors at 606, then the method 600 can continue to 610 where one or more requests can be generated from the compiled query. As discussed above, in some embodiments, generating the requests may comprise generating appropriate requests for each of a plurality of data sources (e.g., data sources 410) specified by the query input. However, as discussed above, the generation step may also include a determination of whether some or all of the data requested by query input been previously requested. If it has been and it is still saved in a memory, then requests for the saved data may not be generated. Additionally, in some embodiments, requests for saved data may be made anyway if it is determined that the data in the memory needs to be updated.

At 612, the method transmits the requests for execution to, for instance, the API 508 and/or adaptor 408. The API 508 and/or adaptor 408 can then transmit the requests to the various data sources 410 and return the resulting data to, e.g., the execution service 406 at 614. The data from the data sources 410 can also be further processed at 614 according to various embodiments. For instance, the execution service 406 may process the received data by performing various database operations (e.g., join, aggregate, and the like) on received data. After processing the data, the method transmits the results of the processed data to the user at 616.

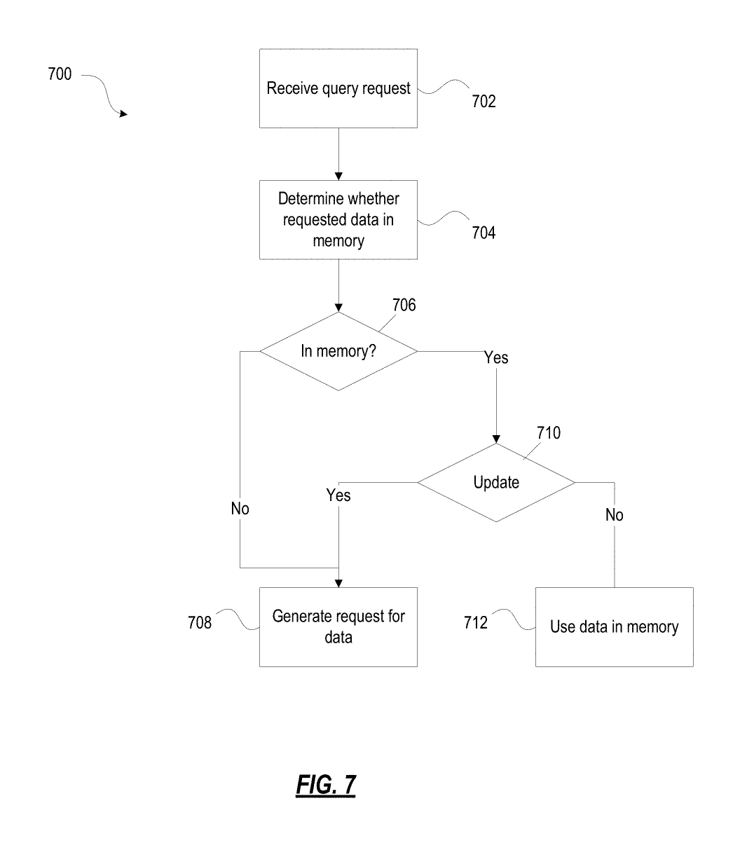

FIG. 7 is a flowchart depicting a method 700 according to various embodiments. To aid understanding, FIG. 7 will be described with reference to FIGS. 4, 5, and 6 but it should be understood that the method 700 is not limited to the specific embodiments described in connection with those figures.

As shown in FIG. 7, method 700 begins at 702 when a query request is received, for instance, by execution service 406. The execution service 406 can, at 704, determine whether some or all of the requested data is in a memory associated with the execution service. If some or all of the requested data is already in memory at 706, then the method proceeds to 710 where is determined whether the data in memory should be updated. For instance, in some embodiments, the data may be updated if it has not been updated for a predetermined amount of time. Additionally, in some embodiments, the metadata object 414 may specify when and whether old or new data should be used. It is also possible in some embodiments for certain kinds of data to always require an update. At any rate, if at 710, the method 700 determines that the data does not need to be updated, then the data in memory is used at 712 and no request for the data in memory is generated. However, if at 710, it is determined that the data does need to be updated, then a request is generated at 708. Similarly, if at 706, it is determined that the requested data is not in memory, then a proper request can be generated at 708. According to various embodiments, the request at 708 may be generated in accordance with the processes and methods described with respect to FIGS. 4, 5, and 6.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method of performing a query, comprising:
receiving a metadata object requesting data from a plurality of data sources;
generating one or more queries corresponding to one or more of the plurality of data sources from the metadata object;
transmit the one or more queries to the one or more data sources; and
storing one or more results from the one or more queries in a block memory.

2. The method of claim 1, further comprising:
determining that at least some of the requested data is present in the block memory; and
declining to generate a query corresponding to the requested data that is present in the block memory.

3. The method of claim 1, wherein the metadata object is a user-generated object.

4. The method of claim 1, wherein the metadata object defines one or more of a data source, filter conditions, sorting conditions, aggregation criteria.

5. The method of claim 1, further comprising:
updating the one or more queries at a pre-determined interval.

6. The method of claim 5, wherein the pre-determined interval is defined by the received metadata object.

7. The method of claim 1, further comprising:
storing the metadata object for later execution.

8. The method of claim 1, further comprising:
performing one or more operations on the one or more results from the one or more queries based on an operation specified in the metadata object.

9. The method of claim 8, further comprising:
storing the result of the one or more operations in the block memory.

10. The method of claim 8, further comprising:
transmitting the result of the one or more operations to a remote user device.

11. A system, comprising:
a block memory; and
one or more processors configured to:
receive a metadata object requesting data from a plurality of data sources;
generate one or more queries corresponding to one or more of the plurality of data sources from the metadata object;
transmit the one or more queries on the one or more data sources;
receive the results of the one or more queries from the one or more data sources; and
store one or more results from the one or more queries in the block memory.

12. The system of claim 11, wherein the one or more processors are further configured to:
determine that at least some of the requested data is present in the block memory; and
decline to generate a query corresponding to the requested data that is present in the block memory.

13. The system of claim 11, wherein the metadata object is configured to define one or more of a data source, filter conditions, sorting conditions, aggregation criteria.

14. The system of claim 11, wherein the one or more processors are further configured to update the one or more queries at a pre-determined interval.

15. The system of claim 14, wherein the pre-determined interval is defined by the received metadata object.

16. The system of claim 11, wherein the one or more processors are further configured to store the metadata object for later execution.

17. The system of claim 11, wherein the one or more processors are further configured to:
perform one or more operations on the one or more results from the one or more queries based on an operation specified in the metadata object.

18. The system of claim 17, wherein the one or more processors are further configured to:
store the result of the one or more operations in the block memory.

19. The system of claim 17, wherein the one or more processors are further configured to:
transmit the result of the one or more operations to a remote user device.

20. A non-transitory computer-readable medium containing computer instructions that, when executed by one or more processors, cause the one or more processors to perform operations comprising:
receiving a metadata object requesting data from a plurality of data sources;
generating one or more queries corresponding to one or more of the plurality of data sources from the metadata object;
transmit the one or more queries to the one or more data sources; and
storing one or more results from the one or more queries in a block memory.
